(19) United States
(12) Patent Application Publication
(10) Pub. No.: US 2024/0193644 A1
(43) Pub. Date: Jun. 13, 2024

(54) METHODS AND SYSTEMS FOR MANAGING ONLINE REPUTATION OF DIGITAL PROFILES

(71) Applicant: REAL GRADER, INC, Fairfield, CT (US)

(72) Inventors: Lorin Daniel RADU, Weston, CT (US); Alex MONTALENTI, Miami Beach, FL (US)

(21) Appl. No.: 18/582,590

(22) Filed: Feb. 20, 2024

Related U.S. Application Data
(63) Continuation-in-part of application No. 16/914,356, filed on Jun. 27, 2020, now abandoned.

(51) Int. Cl. G06Q 30/0282; G06Q 50/00

(52) U.S. Cl. CPC G06Q 30/0282; G06Q 50/01

(57) ABSTRACT

Various embodiments of the present disclosure provide methods and systems for managing the online reputation of digital profiles. The method performed by the processor includes analysing a plurality of profile data points of a digital profile of a user. The plurality of profile data points is associated with a corresponding digital platform of a plurality of digital platforms. The plurality of profile data points includes information related to the profile information, profile reviews, and profile settings. The method includes computing a grade for each of the plurality of profile data points associated with the plurality of digital platforms based at least on analysis of the plurality of profile data points. Further, the method includes computing a reputation grade indicative of the online reputation and listings of the digital profile associated with the user based at least on the grade assigned for the plurality of profile data points.

### TECHNICAL FIELD

Embodiments of the disclosure relate generally to the field of microsite management and, more particularly to, methods and systems for managing the online reputation of digital profiles by implementing analytical techniques.

### BACKGROUND

The proliferation of the internet and the exponential growth of online platforms have enabled individuals to create and maintain digital profiles on a wide array of websites, social media networks, and other online platforms. These profiles often encompass personal, professional, and social information. One such use case that uses digital profile data is digital business cards. Digital business cards provide a modern way to exchange information with potential customers. They can be easily saved and updated without wasting time, money, and effort. The rise of online networking platforms and the proliferation of digital communication channels have led to the widespread adoption of digital business cards. These digital representations of traditional business cards provide a convenient and efficient means for sharing professional information. Another use case would be a real estate website that offers users an on-demand experience for selling, buying, and renting. The real-estate website will have an associated reputation depending upon the user visits, profile completeness, customer reviews, etc.

However, in the digital realm, managing one's reputation goes beyond sharing contact information. It involves monitoring and controlling the information available about an individual or business online, including reviews, endorsements, and other forms of public feedback. Existing methods for assessing online reputation often involve manual tracking of online mentions, customer reviews, and social media activity. These approaches can be time-consuming, inefficient, and subject to biases.

Automated tools and algorithms have been developed to aid in monitoring online reputation. However, many of these solutions lack comprehensive assessment capabilities. Additionally, these tools may not effectively aggregate data from diverse sources, analyse sentiment, or provide actionable insights to enhance one's online reputation effectively.

In light of the above discussion, there is a need for an automated and robust method and system that can accurately measure and manage the online reputation of individuals or entities utilizing digital business cards. This invention addresses the existing gaps by offering an innovative approach to assess and enhance online reputation through sophisticated analytics and proactive reputation management strategies for digital business card users.

### SUMMARY

Various embodiments of the present disclosure provide methods and systems for managing online reputation of digital profiles by implementing analytical techniques.

In an embodiment, a computer-implemented method is disclosed. The method performed by a processor includes analysing a plurality of profile data points associated with a digital profile of a user. The plurality of profile data points is associated with a corresponding digital platform of a plurality of digital platforms. The plurality of profile data points includes information related to at least one of the profile information, profile reviews, and profile settings. The method includes computing a grade for each of the plurality of profile data points associated with the plurality of digital platforms based at least on analysis of the plurality of profile data points. The grade indicates a weightage of each of the plurality of profile data points. Further, the method includes computing a reputation grade indicative of the online reputation and listings of the digital profile associated with the user based at least on the grade assigned for the plurality of profile data points.

In another embodiment, a server system is disclosed. The server system includes a communication interface, a memory storing executable instructions, and a processor operatively coupled with the communication interface and the memory. The processor is configured to execute the executable instructions to cause the application server to at least analyse a plurality of profile data points associated with a digital profile of a user. The plurality of profile data points is associated with a corresponding digital platform of a plurality of digital platforms. The plurality of profile data points includes information related to at least one of the profile information, profile reviews, and profile settings. The processor is configured to compute a grade for each of the plurality of profile data points associated with the plurality of digital platforms based at least on analysis of the plurality of profile data points. The grade indicates a weightage of each of the plurality of profile data points. Further, the processor is configured to compute a reputation grade indicative of the online reputation and listings of the digital profile associated with the user based at least on the grade assigned for the plurality of profile data points.

In another embodiment, a non-transitory computer-readable storage medium including computer-executable instructions that, when executed by at least a processor of a server system, cause the server system to perform a method comprising analysing a plurality of profile data points associated with a digital profile of a user. The plurality of profile data points is associated with a corresponding digital platform of a plurality of digital platforms. The plurality of profile data points includes information related to at least one of the profile information, profile reviews, and profile settings. The server system performs the method of computing a grade for each of the plurality of profile data points associated with the plurality of digital platforms based at least on analysis of the plurality of profile data points. The grade indicating a weightage of each of the plurality of profile data points. Further, the server system performs the method of computing a reputation grade indicative of the online reputation and listings of the digital profile associated with the user based at least on the grade assigned for the plurality of profile data points.

### BRIEF DESCRIPTION OF THE FIGURES

For a more complete understanding of example embodiments of the present technology, reference is now made to the following descriptions taken in connection with the accompanying drawings:

FIG. 1 is an illustration of an environment, where at least some example embodiments can be implemented;

FIG. 2 illustrates a simplified block diagram of a server system, in accordance with an embodiment of the present disclosure;

FIGS. 3A and 3B, collectively illustrate an example representation of a user interface (UI) depicting an analytic report generated for a digital platform on which a digital profile of a user is displayed, in accordance with an embodiment of the present disclosure;

FIG. 4 is an example representation of a user interface (UI) depicting cumulative grades assigned to the digital platforms, in accordance with an embodiment of the present disclosure;

FIG. 5 is an example representation of a user interface (UI) depicting a dashboard to the user, in accordance with an embodiment of the present disclosure;

FIGS. 6A and 6B, collectively represent user interfaces (UIs) for seeking reviews for the digital profile from at least one client user, in accordance with an embodiment of the present disclosure.

FIG. 7 illustrates a flow diagram of a computer-implemented method for managing the online reputation of the digital profile of the user, in accordance with an embodiment of the present disclosure; and

FIG. 8 is a simplified block diagram of an electronic device capable of implementing various embodiments of the present disclosure.

The drawings referred to in this description are not to be understood as being drawn to scale except if specifically noted, and such drawings are only exemplary in nature.

### DETAILED DESCRIPTION

In the following description, for purposes of explanation, numerous specific details are set forth in order to provide a thorough understanding of the present disclosure. It will be apparent, however, to one skilled in the art that the present disclosure can be practiced without these specific details. In other instances, systems and methods are shown in block diagram form only in order to avoid obscuring the present disclosure.

Reference in this specification to “one embodiment” or “an embodiment” means that a particular feature, structure, or characteristic described in connection with the embodiment is included in at least one embodiment of the present disclosure. The appearance of the phrase “in one embodiment” in various places in the specification is not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

### Overview

Various example embodiments of the present disclosure provide methods and systems for managing a digital profile of users.

The digital business card is a microsite created in the form of one or more progressive web pages. The microsite is a small, specialized website typically created for a specific purpose or campaign. It is separate from a company's main website and often serves as a focused platform to promote a particular product, event, marketing campaign, or initiative. Microsites are designed to target a specific audience and convey a particular message or set of information. A digital profile is one such microsite and is made using the user profile information which further includes personal information, such as name, address, designation, company name, etc., and one or more social media links, one or more photos, and one or more videos associated with the user. The created digital profile is then available to the user. The user thereafter shares the digital profile with the clients, customers or other contacts.

Therefore, it is important to accurately measure and manage the online reputation of individuals or entities utilizing digital profiles. In other words, it is important to monitor the online reputation and therefore measure the completion and correctness of the profiles, websites, etc. for each user associated with the digital profiles.

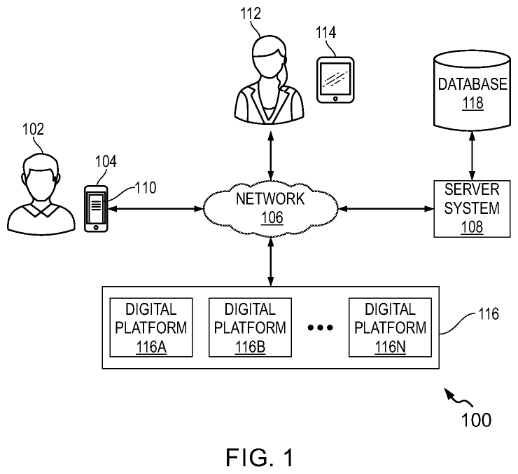

Various embodiments of the present invention are described hereinafter with reference to FIG. 1 to FIG. 8.

FIG. 1 is an illustration of an environment 100 related to at least some example embodiments of present disclosure. Although the environment 100 is presented in one arrangement, other arrangements are also possible where the parts of the environment 100 (or other parts) are arranged or interconnected differently. The environment 100 includes but is not limited to, a wireless communication network (e.g., a network 106) that connects entities such as a user 102, and at least one client user 112. The user 102 is depicted to be associated with an electronic device 104 (hereinafter referred to as ‘user device 104’). The client user 112 is depicted to be associated with an electronic device 114 (hereinafter referred to as ‘customer device 114’). The user 102 can be a sales person working for a consumer goods company, a corporate body, a manufacturing sector, or any entity who wants to create a digital profile that can be made available to client users (e.g., the client user 112). In other words, the digital profile may be a digital business card, a visiting card, a call card, and the like.

In one example, the client user 112 may be a customer or any other entity accessing or browsing on a digital platform. As such, the client user 112 may be rendered with the digital profile of the user 102 on the digital platform. This enables a primary contact between the user 102 and the client user 112. The client user 112 may be allowed to interact with the digital profile of the user 102 by providing one or more inputs in the electronic device 114 which will be explained further in detail. It should be noted that the one user and one client user are shown for the sake of simplicity to explain the present disclosure; in the application, there will be many such users and customers.

Various entities in the environment 100 may connect to a network 106 in accordance with various wired and wireless communication protocols, such as Transmission Control Protocol and Internet Protocol (TCP/IP), User Datagram Protocol (UDP), 2nd Generation (2G), 3rd Generation (3G), 4th Generation (4G), 5th Generation (5G) communication protocols, Long Term Evolution (LTE) communication protocols, or any combination thereof. In some instances, the network 106 may include a secure protocol (e.g., Hypertext Transfer Protocol (HTTP)), and/or any other protocol, or set of protocols. In an example embodiment, the network 114 may include, without limitation, a local area network (LAN), a wide area network (WAN) (e.g., the Internet), a mobile network, a virtual network, and/or another suitable public and/or private network capable of supporting communication among two or more of the entities illustrated in FIG. 1, or any combination thereof.

In an embodiment, the user device 104 is an electronic device enabling the user 102 to access data from a plurality of digital platforms 116 such as a digital platform 116A, a digital platform 116B, . . . a digital platform 116N. The digital platforms 116 may be created and hosted by respective servers. The user 102 accesses the application 110 for sharing of the digital profile of the user 102 on the digital platforms 116 which will be explained further in detail. The user device 104 may be any communication device having hardware components for enabling User Interfaces (UIs) of the digital profile to be presented on the user device 104. The user device 104 and the electronic device 114 (hereinafter interchangeably referred to as ‘the device 114’) may be capable of being connected to a wireless communication network (such as the network 106). Examples of the user device 104 and the device 114 include a mobile phone, a smart telephone, a computer, a laptop, a PDA (Personal Digital Assistant), a Mobile Internet Device (MID), a tablet computer, an Ultra-Mobile personal computer (UMPC), a phablet computer, a handheld personal computer and the like.

The environment 100 further includes a server system 108. The server system 108 is configured to host and manage a digital profile managing application 110. The digital profile managing application 110 (hereinafter referred to as ‘the application 110’) is a set of computer-executable codes configured to allow the user 102 to share the digital profile of the user 102 to the client user 112. In one embodiment, the application 110 may be accessed as a web based application on the user device 104. In another embodiment, the user device 104 may access an instance of the application 110 from the server system 108 for installing on the user device 104 using application stores associated with operating systems such as Apple IOS®, Android™ OS, Google Chrome OS, Symbian OS®, Windows Mobile® OS, and the like.

Further, the server system 108 may be embodied in at least one computing device in communication with the network 106. The server system 108 may be specifically configured, via executable instructions to perform one or more of the operations described herein. In general, the server system 108 may be configured to measure the completeness and correctness of the digital profile for the user 102. In particular, the server system 108 performs analysis of data points on each of the digital platforms 116 for allowing the user 102 to manage the digital profile on the digital platforms 116. In an embodiment, the server system 108 may be communicably coupled to the respective servers of each of the digital platforms 116 via the network 106. This enables the server system 108 to perform analysis of online presence of the digital profile of the user 106 in the respective digital platforms 116.

In at least one example embodiment, the user 102 may create a digital profile and further share the digital profile with the client user 112 on their device 114. The digital profile may be shared using the digital platforms 116. It is to be noted that the digital platforms 116 may include online websites, professional websites, social networking platforms, and the like. For example, the digital platform 116A may be a social networking platform on which the user 102 shares the digital profile with the client user 112. In another example, the digital platform 116B may be the online website on which the user 102 associated with the digital profile may be searched by the client user 112. In yet another example, the digital platform 116N may be a professional website such as the real-estate website in which user 102 is a professional and has an associated digital profile or any other professional website (e.g., mortgage, medical offices, gyms).

Further, the server system 108 may monitor online reputation (or online presence) and listings of the digital profile of the user 102 on the digital platforms 116. In at least one example embodiment, the server system 108 is configured to continuously monitor and determine the online reputation of the digital profile associated with the user 102. In particular, the server system 108 analyses a plurality of profile data points associated with the digital profile of a user. The profile data points are associated with a corresponding digital platform of the digital platforms 116. The profile data points include information related to at least one of the profile information, profile reviews, and profile settings. The server system 108 is configured to record the user profile information, the profile reviews and the profile settings in a database 118 associated with the server system 108.

Thereafter, the server system 108 is configured to compute a grade for each of the profile data points associated with the digital platforms 116 based at least on analysis of the profile data points. The grade indicates a weightage of each of the profile data points in the digital platform. Further, the server system 108 may compute a cumulative grade for each of the digital platforms 116A-116N based at least on the grade assigned to each of the profile data points associated with the corresponding digital platform 116A-116N. The server system 108 further computes a reputation grade indicative of the online reputation and existence of the user 102 based at least on the cumulative grade of each of the digital platforms 116.

In addition, the server system 108 manages the online reputation of the digital profile associated with the user 102 by continuously monitoring and updating the online presence, user related content, user related reviews, and posts. It is noted that the server system 108 may implement an algorithm to periodically analyze the profile data points in each digital platform 116A-116N, and other related data and track the changes in information, reviews, content, and settings. Further, the server system 108 is configured to the server system 108 provide recommendations to the user 102 to have consistent and complete online branding, thus resulting the user 102 to have ongoing activity and expansion of content along with engagement on all the associated digital platforms 116.

The number and arrangement of systems, devices, and/or networks shown in FIG. 1 are provided as an example. There may be additional systems, devices, and/or networks; fewer systems, devices, and/or networks; different systems, devices, and/or networks, and/or differently arranged systems, devices, and/or networks than those shown in FIG. 1. Furthermore, two or more systems or devices shown in FIG. 1 may be implemented within a single system or device, or a single system or device shown in FIG. 1 may be implemented as multiple, distributed systems or devices. Additionally or alternatively, a set of systems (e.g., one or more systems) or a set of devices (e.g., one or more devices) of the environment 100 may perform one or more functions described as being performed by another set of systems or another set of devices of the environment 100.

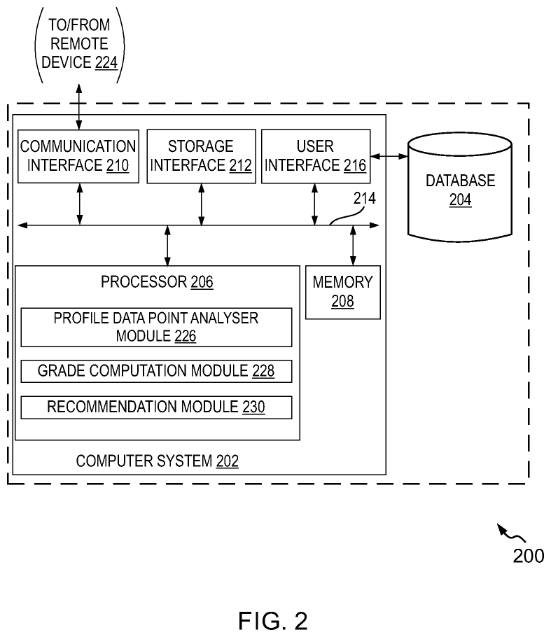

FIG. 2 illustrates a simplified block diagram of a server system 200, in accordance with an embodiment of the present disclosure. It is noted that the server system 200 is identical to the server system 108 of FIG. 1. In various implementations, the server system 200 may be implemented within a third-party server. In some embodiments, the server system 200 is embodied as a cloud-based and/or Software as a Service (SaaS) based architecture. The server system 200 includes a computer system 202 and a database 204. It is noted that the database 204 is identical to the database 118 of FIG. 1. The computer system 202 includes at least one processor 206 for executing instructions, a memory 208, a communication interface 210, a user interface 216 and a storage interface 212 that communicate with each other via a bus 214.

In some embodiments, the database 204 is integrated within the computer system 202. For example, the computer system 202 may include one or more hard disk drives as the database 204. The database 204 is configured to store user profile information, profile reviews, profile settings, and the like. The user interface 216 is any component capable of providing an administrator (not shown) of the server system 200, the ability to interact with the server system 200. This user interface 216 may be a GUI or Human Machine Interface (HMI) that can be used by the administrator (not shown) to configure the various operational parameters of the server system 200. The user interface 216 is in communication with the database 204. The user interface 216 is configured to present one or more UIs for facilitating the review and sharing of the digital profile by the user 102 using an output interface of the device 104 with other individuals such as the customer 112. Examples of the output interface associated with electronic device 104 may include, but are not limited to, a display such as a light emitting diode (LED) display, a thin-film transistor (TFT) display, a liquid crystal display, an active-matrix organic light-emitting diode (AMOLED) display, and the like. In an embodiment, the output interface is based on application programming interfaces (APIs).

The storage interface 212 is any component capable of providing the processor 206 with access to the database 204. The storage interface 212 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204. In one non-limiting example, the database 204 is configured to store user profile information, links to social networking websites related to the user, and the like.

The processor 206 includes suitable logic, circuitry, and/or interfaces to execute operations for computing the grade associated with the plurality of data points associated with the digital business card of the user, computing the reputation grade for the user, providing the recommendation to the user, and the like. In other words, the processor 206 includes suitable logic, circuitry, and/or interfaces to execute operations for evaluating the grade for profile data points and providing recommendations to improve the reputation of the user 102. Examples of the processor 206 include but are not limited to, an Application-Specific Integrated Circuit (ASIC) processor, a Reduced Instruction Set Computing (RISC) processor, a Graphical Processing Unit (GPU), a Complex Instruction Set Computing (CISC) processor, a Field-Programmable Gate Array (FPGA), and the like.

The memory 208 includes suitable logic, circuitry, and/or interfaces to store a set of computer-readable instructions for performing various operations described herein. Examples of the memory 208 include a Random-Access Memory (RAM), a Read-Only Memory (ROM), a removable storage drive, a Hard Disk Drive (HDD), and the like. It will be apparent to a person skilled in the art that the scope of the disclosure is not limited to realizing the memory 208 in the server system 200, as described herein. In another embodiment, the memory 208 may be realized in the form of a database server or a cloud storage working in conjunction with the server system 200, without departing from the scope of the present disclosure.

The processor 206 is operatively coupled to the communication interface 210, such that the processor 206 is capable of communicating with a remote device (i.e., to/from a remote device 224) such as a third-party server (not shown), or communicating with any entity connected to the network 106 (as shown in FIG. 1). Herein, the third-party server may be any computing server that operates uses the server system 200 to manage the digital profile of the user 102.

It is noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

In one implementation, the processor 206 includes a profile data point analysis module 226, a grade computing module 228, and a recommendation module 230. It should be noted that components, described herein, such as the profile data point analysis module 226, the grade computing module 228, and the recommendation module 230 can be configured in a variety of ways, including electronic circuitries, digital arithmetic, and logic blocks, and memory systems in combination with software, firmware, and embedded technologies.

The profile data point analysis module 226 includes suitable logic and/or interfaces to analyze various profile data points associated with the plurality of digital platforms 116. In particular, the profile data point analysis module 226 is configured to analyze the profile data points associated with a digital profile of the user 102 on a different digital platform (e.g., the digital platforms 116). For example, the profile data points associated with each of the digital platforms 116 may be approximately 180 data points. The 180 profile data points on the digital platforms 116 are analyzed from the profile information, profile reviews, and the profile settings. For example, the profile information may include images (profile and cover), personal details, name of the user 102, address of the user 102, contact information, short bio, and the like. Typically, the profile data points correspond to predefined analytical templates for the digital platforms 116 that are associated with grading the digital profile of the user 102 which will be explained further in detail. In other words, the profile data points are predefined analytical templates for each digital platform 116A-116N that aim to determine the completion and correctness of the digital profile setup for the user 102.

The grade computing module 228 includes specific logic and/or interfaces for computing the grade for each of the profile data points associated with the digital platforms 116 based on the analysis result from the profile data points analysis module 226. For example, the profile data point may be related to the contact information of the user 102. The contact information may include, but not limited to, electronic mail (e-mail) address, phone number, fax, and the like. As such, the grade computing module 228 computes the grade for the profile data point related to the contact information. The grade may be computed as a numerical value or in terms of alphabet code (‘G’—Good, ‘F’—Fair, ‘A’—Average, etc.), or any other format as per the requirement. In one example, the grade may be computed in the form of a numerical value between 1-10 for each of the profile data points of the digital platforms 116. The grade indicates the weightage of each of the profile data points on the corresponding digital platform 116A-116N. It is to be noted that the information in the profile data points associated with the digital profile for each of the digital platforms 116 indicate the online presence/engagement/listings of the digital profile of the user 102 on the digital platforms 116.

In one example scenario, various digital platforms may include specific rules for determining the completeness of each of the profile data points associated with the digital profile of the users. Hence, the information of the profile data points may be graded as ‘10’ indicating completeness of the profile data point for one digital platform (e.g., the digital platform 116A), and may be graded as ‘6’ for the same profile data point on another digital platform (e.g., the digital platform 116B). In another example scenario, the server system 200 may include a predefined set of rules for each of the profile data points for the digital platforms 116A-116N. The server system 200 may communicate the predefined set of rules with the digital platforms 116A-116N for maintaining a standard grading system among each of the digital platforms 116A-116N on which the digital profile will be shared. Thus, the information of each of the profile data point on the digital platforms 116A-116N is graded based on the standard grading system.

Further, the grade computing module 228 computes the cumulative grade for each of the digital platforms 116A-116N based at least on the grade assigned to each of the profile data points associated with the corresponding digital platform 116A-116N. The cumulative grade indicates the online presence/engagement/listings of the digital profile of the user 102 on the corresponding digital platforms 116A-116N. Similar to the grade assigned for the profile data points, the cumulative grade may be in the form of a numerical value (e.g., may be graded on a scale of 1 to 10).

Thereafter, the grade computing module 228 may compute the reputation grade indicative of the online reputation and listings of the digital profile associated with the user based on the grade assigned for the profile data points. In particular, the grade computing module 228 compounds or aggregates the cumulative grade of each of the digital platforms 116 on which the digital profile of the user 102 is shared. The grade computing module 228 computes the reputation grade indicative of the online reputation and listings of the digital profile of the user based at least on the cumulative grade of each of the digital platforms 116. For example, the reputation grade may be in the form of a numerical value ranging between 1 to 100. In other words, the reputation grade is an overall score for the digital profile of the user 102 listed on different digital platforms (e.g., the digital platforms 116).

Additionally, the profile data point analysis module 226 is configured to one or more attributes associated with the digital profile of the user 102 at regular intervals. The attributes correspond to the profile data points, content, and reviews. The reputation grade for the user 102 corresponding to determining at least one attribute is updated for the digital profile associated with the user 102. In particular, the grade computing module 228 with access to the profile data point analysis module 226 dynamically computes the grade for the profile data points, the cumulative grade, and the reputation grade for the digital platforms 116 in case the profile data points on the digital platforms 116 are updated. In other words, the grade computing module 228 periodically analyzes the profile data points on each digital platform 116 and regrades them depending on the changes in profile information, profile reviews, content, and settings.

Further, the processor 206 is configured to determine the online reputation and listings of the digital profile of the user based on accessing search results from one or more search engines. For example, the client users (e.g., the client user 112) may search for the digital profile of the user 102 on the search engines (e.g., search engine of Google™). The processor 206 accesses the search results for the digital profile of the user 102 from the search engines. In other words, the processor 206 analyses the online presence of specific users (e.g., the user 102) by accessing the search results of the search engines for the user 102. The online reputation of the digital profile may be updated based on the frequency or number of searches for the digital profile on the search engines.

Furthermore, the user 102 may get periodic automatic grade checks and updates which can be monitored by the user 102 in their dashboard. In particular, the processor 206 may be configured to generate an analytics report for each of the digital platforms based at least on details of the profile data points, the grade associated with each of the profile data points, the cumulative grade associated with each of the digital platforms 116, and the reputation grade for the digital profile of the user 102. Thus, it is to be noted that the analytics report provides individual grades (i.e., the grade for the profile data points, the cumulative grade of the digital platforms 116) that contribute to the final reputation grade of the user 102.

In addition, the processor 206 is configured to determine one or more errors associated with the digital profile being listed in the plurality of digital platforms. The errors associated with the digital profile of the user 102 may be, but not limited to, incorrect/incomplete information provided in the profile data points, factors associated with the online reputation of the digital profile of the user 102, content, etc. Some non-limiting examples of the factors that affect the online reputation of the digital profile of the user 102 are ensuring the users have a presence on all meaningful professional and social media platforms that impact their line of business, ensuring the users have their profiles correctly set for each digital platform, ensuring the users have consistent and complete branding online, ensuring the users have ongoing activity and expansion of content and engagement on all platforms, ensuring the users have consistent uniform resource locators (URLs) and handle for search engine optimization (SEO) optimization, and insuring the users have unique profiles without duplicates.

The recommendation module 230 includes suitable logic and/or interfaces for generating recommendations to the user 102 of the digital profile based at least on the errors associated with the digital profile in the corresponding digital platform. More specifically, the processor 206 triggers the recommendation module 230 upon identifying the errors associated with the digital profile of the user 102. In this scenario, the recommendation module 230 generates recommendations based on the data analytics or the errors associated with the profile data points. In particular, the recommendation module 230 takes the analytics results received from the profile data point analyser module 226 and the grades received from the grade computing module 228. Based on these inputs the recommendation module 230 provides recommendations to the user 102 for improving the online reputation of the user 102. The recommendations may be in form of a comprehensive report of user's online presence. For example, the recommendation module 230 may provide the user with a recommendation that the profile of the user is not updated and recommends them to update the profile. Another example would be that the recommendation module 230 may provide the user with a recommendation to update his/her cover image. Further, the recommendation module 230 may provide recommendations related to further services associated with the improvement of the online reputation associated with user 102. For example, if the branding of the user is not consistent throughout their online presence then recommendation module 230 provides recommendations to use an online service to implement a consistent branding package.

Additionally, the processor 206 allows users (e.g., the user 102) to find the specific review link and share it with their clients (e.g., the client user 112) for seeking feedback or an online review. Also, the processor 206 allows the user 102 to customize the reviews for the digital profile. In an embodiment, the server system 200 may provide a widget in an application (such as the application 110) to the user 102. The widget may be capable of managing the digital profile associated with the user 102 based on the online reputation and grade. Further, the widget may be capable of performing regular updates of the grade, sending recommendations, and sending alerts based on the updates in the digital profiles, reviews, etc.

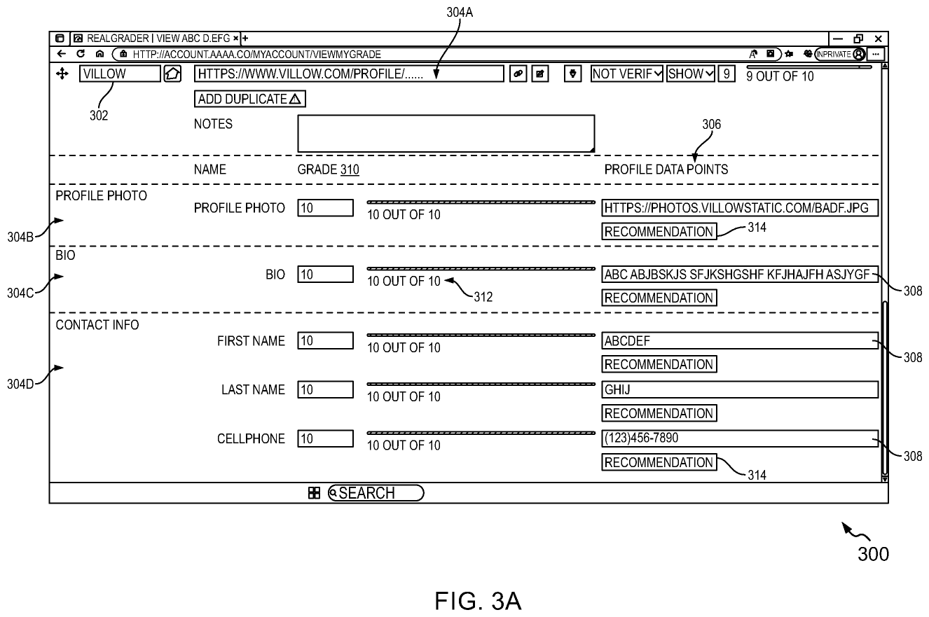

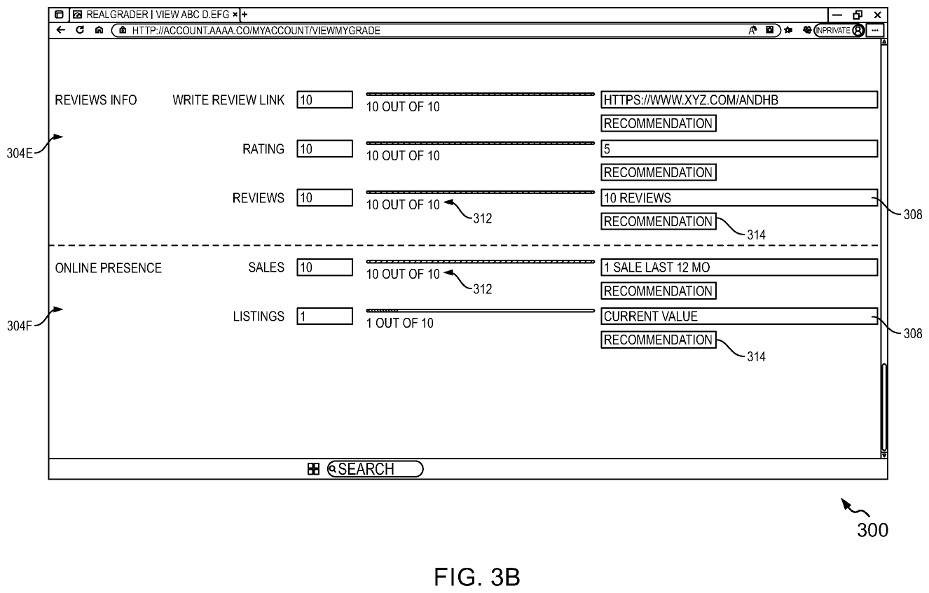

FIGS. 3A and 3B, collectively illustrate an example representation of a user interface (UI) 300 depicting an analytic report generated for a digital platform on which the digital profile of the user 102 is displayed, in accordance with an embodiment of the present disclosure. As shown, the UI 300 is depicted to include a plurality of profile data points 306 associated with a digital platform 302 (exemplarily depicted as ‘VILLOW’). It is to be noted that the digital profile of the user 102 will be displayed or listed in the digital platform 302 (‘VILLOW’). As such, the client user 112 browsing on the digital platform 302 may access the digital profile displayed in the digital platform 302. Further, the profile data points 306 may include information related to the profile information, the profile reviews, and the profile settings. The profile data points 306 are exemplarily categorized into several categories such as, but not limited to, a website link 304A of the digital platform 302, profile photo section 304B, a bio section 304C, a contact information section 304D, a review section 304E, an online presence section 304F. It is to be noted that the profile data points depicted in the UI 300 are for illustration purposes only, and they should not be considered to limit the scope of the present disclosure.

Further, each of the profile data points 306 includes an information field 308 for depicting the information of the respective profile data point (as shown in FIGS. 3A and 3B). The UI 300 is further depicted to indicate a grade associated with each profile data point of the digital platform 302. As shown in FIGS. 3A and 3B, the grade for the profile data points is depicted in a grade section (see, 310) for each profile data point. For example, the profile data point related to ‘Bio’ includes the information entered in the corresponding information field 308. The processor 206 analyses the information entered in the information field 308 for the profile data point related to ‘Bio’ and computes the grade based on the analyses. The grade for ‘Bio’ is exemplarily depicted as ‘10’ in a grade section 310. In addition, the UI 300 is depicted to include a grade value indicator 312 for each of the profile data points. The grade value indicator 312 is scaled between the values 1 to 10. As such, the grade of the profile data points is indicated in the grade value indicator 312 for each of the profile data points. For example, the grade for the profile data point related to ‘Listings’ is assigned to be ‘1’. The value of the grade for the ‘Listings’ is entered in the grade section 310 and indicated in the grade value indicator 312 for the profile data point related to ‘Listings’. The UI 300 is further depicted to include a recommendation field 314 for each of the profile data points. As explained above, the processor 206 generates the recommendations for the profile data points based on the data analytics or the errors associated with the profile data points. The recommendations generated by the processor 206 may be indicated in the recommendation field 314 for the corresponding profile data points.

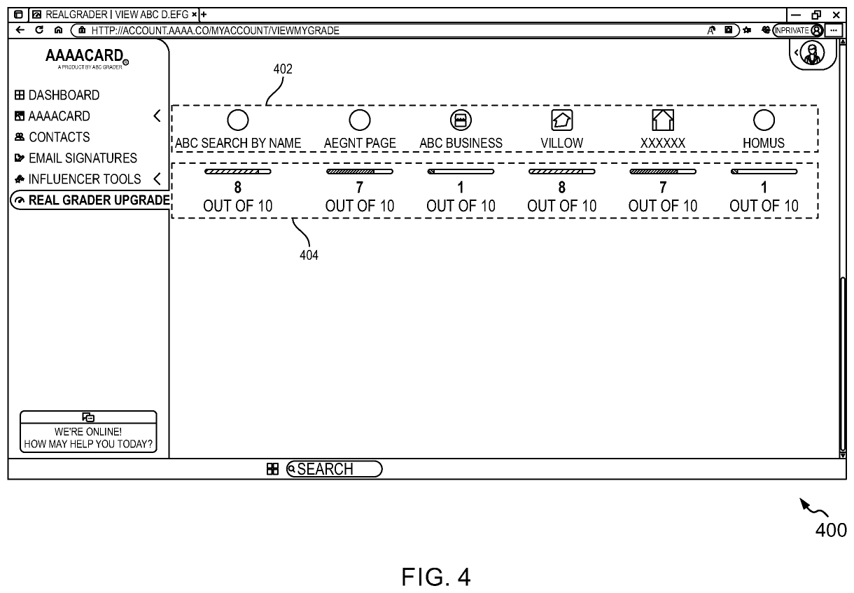

Referring to FIG. 4, an example representation of a user interface (UI) 400 depicting cumulative grades assigned to the digital platforms is illustrated. The UI 400 is depicted to include a plurality of digital platforms 402. As explained above, the digital profile of the user 102 is listed or displayed in the digital platforms 402. Further, each of the digital platforms 402 is associated with the profile data points as explained with reference to FIG. 1 to FIG. 3B. Each of the profile data points of the digital platforms 402 is assigned with the grade. Thereafter, a cumulative grade (see, 404) is computed for each of the digital platforms 402 based at least on the grade assigned to each of the profile data points associated with the corresponding digital platform 402.

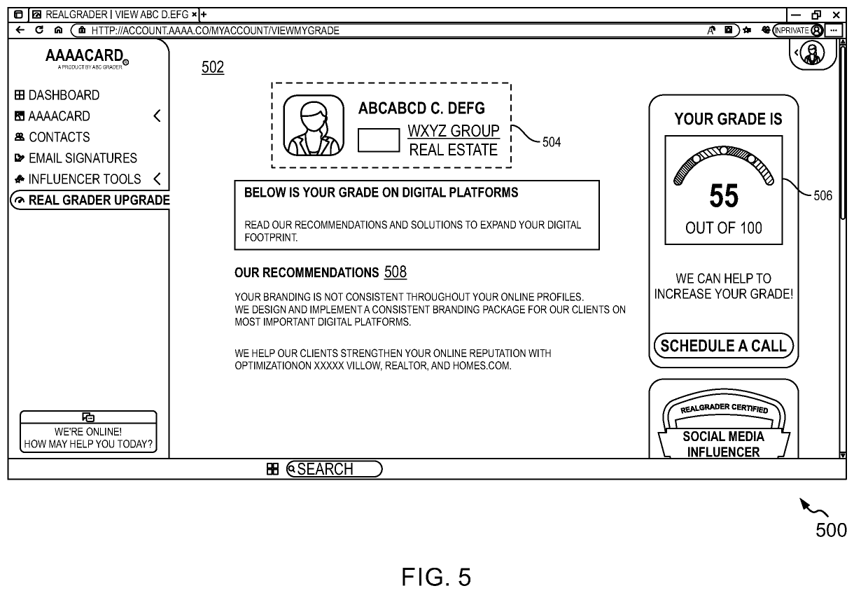

Referring to FIG. 5 an example representation of a user interface (UI) 500 depicting a dashboard 502 is illustrated. The dashboard 502 is depicted to include a profile section 504 associated with the digital profile of the user 102. The profile section 504 may include details related to profile photo, profile name, a short bio and the like. Further, the dashboard 502 is depicted to include a reputation grade 506 (exemplarily depicted as ‘55 out of 100’). As explained above, the reputation grade 506 is indicative of the online reputation and listings of the digital profile of the user 102. The reputation grade 506 is computed based at least on the cumulative grade of each of the plurality of digital platforms (e.g., the digital platforms 402). In addition, the dashboard 502 is depicted to include a recommendation section 508. The recommendation section 508 includes recommendations for managing the online presence of the digital profile of the user 102 in various digital platforms (e.g., the digital platforms 402).

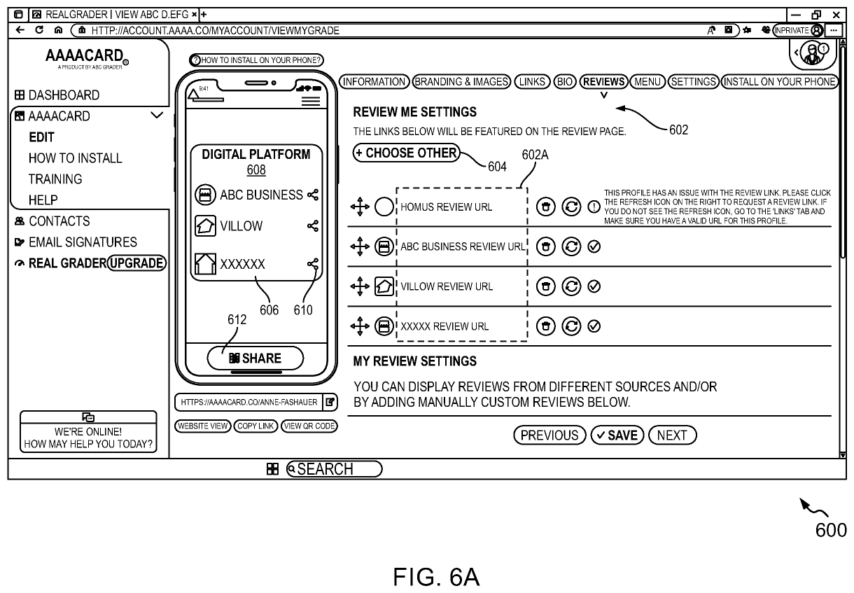

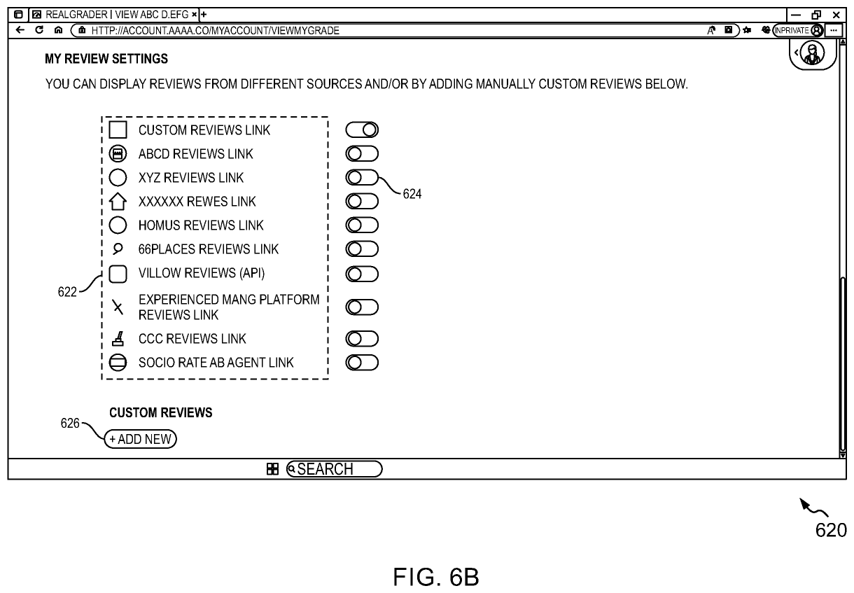

FIGS. 6A and 6B, collectively represent user interfaces (UIs) for seeking reviews for the digital profile from at least one client user, in accordance with an embodiment of the present disclosure.

Referring to FIG. 6A, a user interface (UI) 600 depicting a review link section 602. The review link section 602 is depicted to include an option 604 (exemplarily depicted as ‘CHOOSE OTHER’). The user 102 may create a review link (see, 602A) for digital platforms (see, 606) by providing a selection input on the option 604. In particular, a drop-down list may be overlaid to the user 102 upon selecting the option 604. The drop-down list may include a list of digital platforms (not shown in Figures) in which the digital profile is rendered. The user 102 may select the digital platforms 606 from the list of digital platforms and the processor 206 creates the review link for the selected digital platforms 606. The review link 602A and the digital platforms 606 are depicted in the review link section 602. Further, the selected digital platforms 606 may be rendered in a digital platform section 608.

Further, the user 102 may provide an input on an actionable button 610 associated with each of the digital platforms 606 in the digital platform section 608 for transmitting the review link to the client user 112. The user 102 may transmit the review link to the client user based on analysing one or more factors related to interactions of the client user 112 with the digital profile of the user 102. In addition, the user 102 may transmit the review link 602A of all the digital platforms 606 to the client user 112 in a single instance by providing input on a button 612 (exemplarily depicted as ‘SHARE’).

Referring to FIG. 6B, a user interface (UI) 620 is depicted to the user 102 for allowing customization of the reviews for the digital profile. The UI 620 is depicted to include a list of review links 622 for the digital platforms in which the digital profile of the user 102 is rendered. In addition, the user 102 may provide at least one input related to customization of the reviews for the digital profile for at least controlling the display of reviews for the digital profile and uploading custom reviews for the digital profile. More specifically, each review link of the list of review links 622 is associated with a toggle button 624. The user 102 may provide the input on the toggle button 624 for selecting the reviews of the digital platforms to be displayed for the digital profile of the user 102. Further, the user 102 may upload custom reviews for the digital profile of the user 102 by providing the input on a button 626. Upon selecting the button 626, the user 102 may be provided with a user interface (UI) (not shown in Figures) for entering details of the custom review and uploading the custom review for the digital profile. It is to be noted that, customization of the reviews for the digital profile allows the user 102 to maintain the online reputation and listings of the digital profile by giving a first glance to the at least one client user 112 to the top rated reviews of the digital profile.

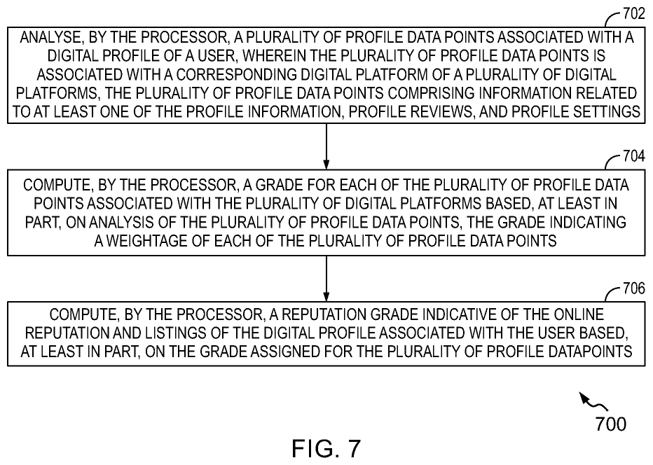

FIG. 7 illustrates a flow diagram of a computer-implemented method 700 for managing the online reputation of the digital profile of the user 102, in accordance with an embodiment of the present disclosure. The method 700 depicted in the flow diagram may be executed by, for example, the server system 200 or the server system 108. Operations of the flow diagram of the method 700, and combinations of the operations in the flow diagram of the method 700, may be implemented by, for example, hardware, firmware, a processor, circuitry, and/or a different device associated with the execution of software that includes one or more computer program instructions. It is noted that the operations of the method 700 can be described and/or practiced by using a system other than these server systems. The method 700 starts at operation 702.

At operation 702, the method 700 includes analysing, by the processor 206, a plurality of profile data points associated with a digital profile of a user 102. The plurality of profile data points is associated with a corresponding digital platform of a plurality of digital platforms. The plurality of profile data points includes information related to at least one of the profile information, profile reviews, and profile settings.

At operation 704, the method 700 includes computing, by the processor 206, a grade for each of the plurality of profile data points associated with the plurality of digital platforms based at least on analysis of the plurality of profile data points. The grade indicates a weightage of each of the plurality of profile data points.

At operation 706, the method 700 includes computing, by the processor 206, a reputation grade indicative of the online reputation and listings of the digital profile associated with the user based at least on the grade assigned for the plurality of profile data points.

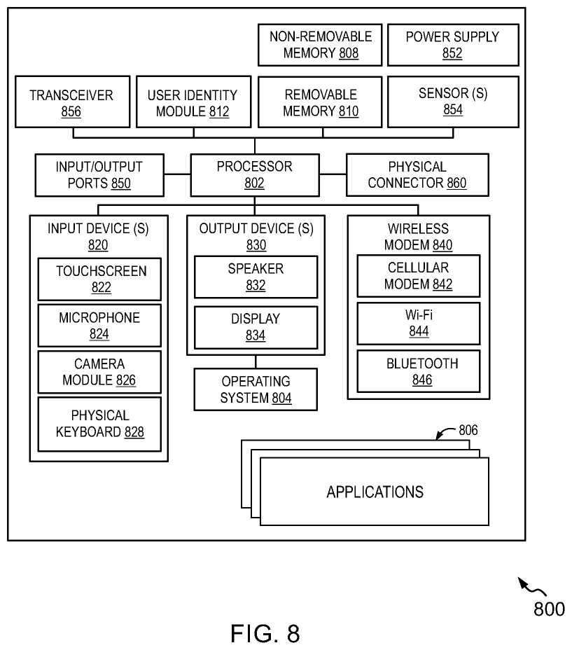

FIG. 8 is a simplified block diagram of an electronic device 800 capable of implementing various embodiments of the present disclosure. For example, the electronic device 800 may correspond to the user devices 104 and 114 of FIG. 1. The electronic device 800 is depicted to include one or more applications 806. For example, the one or more applications 806 may include components of the application 110 of FIG. 1. One of the one or more applications 806 installed on the electronic device 800 is capable of communicating with a server (i.e., the server system 200 or the server system 108) for managing the online reputation of the digital profile.

It should be understood that the electronic device 800 as illustrated and hereinafter described is merely illustrative of one type of device and should not be taken to limit the scope of the embodiments. As such, it should be appreciated that at least some of the components described below in connection with the electronic device 800 may be optional and thus in an embodiment may include more, fewer, or different components than those described in connection with the embodiment of the FIG. 8. As such, among other examples, the electronic device 800 could be any of a mobile electronic device, for example, cellular phones, tablet computers, laptops, mobile computers, personal digital assistants (PDAs), mobile televisions, mobile digital assistants, or any combination of the aforementioned, and other types of communication or multimedia devices.

The illustrated electronic device 800 includes a controller or a processor 802 (e.g., a signal processor, microprocessor, ASIC, or other control and processing logic circuitry) for performing such tasks as signal coding, data processing, image processing, input/output processing, power control, and/or other functions. An operating system 804 controls the allocation and usage of the components of the electronic device 800 and supports for one or more operations of the application (see, the applications 806) that implements one or more of the innovative features described herein. In addition, the applications 806 may include common mobile computing applications (e.g., telephony applications, email applications, calendars, contact managers, web browsers, messaging applications) or any other computing application.

The illustrated electronic device 800 includes one or more memory components, for example, a non-removable memory 808 and/or removable memory 810. The non-removable memory 808 and/or the removable memory 810 may be collectively known as a database in an embodiment. The non-removable memory 808 can include RAM, ROM, flash memory, a hard disk, or other well-known memory storage technologies. The removable memory 810 can include flash memory, smart cards, or a Subscriber Identity Module (SIM). The one or more memory components can be used for storing data and/or code for running the operating system 804 and the applications 806. The electronic device 800 may further include a user identity module (UIM) 812. The UIM 812 may be a memory device having a processor built in. The UIM 812 may include, for example, a subscriber identity module (SIM), a universal integrated circuit card (UICC), a universal subscriber identity module (USIM), a removable user identity module (R-UIM), or any other smart card. The UIM 812 typically stores information elements related to a mobile subscriber. The UIM 812 in the form of the SIM card is well known in Global System for Mobile (GSM) communication systems, Code Division Multiple Access (CDMA) systems, or with third-generation (3G) wireless communication protocols such as Universal Mobile Telecommunications System (UMTS), CDMA9000, wideband CDMA (WCDMA) and time division-synchronous CDMA (TD-SCDMA), or with fourth-generation (4G) wireless communication protocols such as LTE (Long-Term Evolution).

The electronic device 800 can support one or more input devices 820 and one or more output devices 830. Examples of the input devices 820 may include, but are not limited to, a touch screen/a display screen 822 (e.g., capable of capturing finger tap inputs, finger gesture inputs, multi-finger tap inputs, multi-finger gesture inputs, or keystroke inputs from a virtual keyboard or keypad), a microphone 824 (e.g., capable of capturing voice input), a camera module 826 (e.g., capable of capturing still picture images and/or video images) and a physical keyboard 828. Examples of the output devices 830 may include, but are not limited to, a speaker 832 and a display 834. Other possible output devices can include piezoelectric or other haptic output devices. Some devices can serve more than one input/output function. For example, the touch screen 822 and the display 834 can be combined into a single input/output device.

A wireless modem 840 can be coupled to one or more antennas (not shown in FIG. 8) and can support two-way communications between the processor 802 and external devices, as is well understood in the art. The wireless modem 840 is shown generically and can include, for example, a cellular modem 842 for communicating at long range with the mobile communication network, a Wi-Fi compatible modem 844 for communicating at short range with an external Bluetooth-equipped device or a local wireless data network or router, and/or a Bluetooth-compatible modem 846. The wireless modem 840 is typically configured for communication with one or more cellular networks, such as a GSM network for data and voice communications within a single cellular network, between cellular networks, or between the electronic device 800 and a public switched telephone network (PSTN).

The electronic device 800 can further include one or more input/output ports 850, a power supply 852, one or more sensors 854 for example, an accelerometer, a gyroscope, a compass, or an infrared proximity sensor for detecting the orientation or motion of the electronic device 800 and biometric sensors for scanning biometric identity of an authorized user, a transceiver 856 (for wirelessly transmitting analog or digital signals) and/or a physical connector 860, which can be a USB port, IEEE 1294 (FireWire) port, and/or RS-232 port. The illustrated components are not required or all-inclusive, as any of the components shown can be deleted and other components can be added.

The disclosed method with reference to FIG. 7, or one or more operations of the server system 200 may be implemented using software including computer-executable instructions stored on one or more computer-readable media (e.g., non-transitory computer-readable media, such as one or more optical media discs, volatile memory components (e.g., DRAM or SRAM), or non-volatile memory or storage components (e.g., hard drives or solid-state non-volatile memory components, such as Flash memory components) and executed on a computer (e.g., any suitable computer, such as a laptop computer, netbook, Web book, tablet computing device, smartphone, or other mobile computing devices). Such software may be executed, for example, on a single local computer or in a network environment (e.g., via the Internet, a wide-area network, a local-area network, a remote web-based server, a client-server network (such as a cloud computing network), or other such networks) using one or more network computers. Additionally, any of the intermediate or final data created and used during implementation of the disclosed methods or systems may also be stored on one or more computer-readable media (e.g., non-transitory computer-readable media) and are considered to be within the scope of the disclosed technology. Furthermore, any of the software-based embodiments may be uploaded, downloaded, or remotely accessed through a suitable communication means. Such a suitable communication means includes, for example, the Internet, the World Wide Web, an intranet, software applications, cable (including fiber optic cable), magnetic communications, electromagnetic communications (including RF, microwave, and infrared communications), electronic communications, or other such communication means.

Although the invention has been described with reference to specific exemplary embodiments, it is noted that various modifications and changes may be made to these embodiments without departing from the broad spirit and scope of the invention. For example, the various operations, blocks, etc., described herein may be enabled and operated using hardware circuitry (for example, complementary metal oxide semiconductor (CMOS) based logic circuitry), firmware, software and/or any combination of hardware, firmware, and/or software (for example, embodied in a machine-readable medium). For example, the apparatuses and methods may be embodied using transistors, logic gates, and electrical circuits (for example, application-specific integrated circuit (ASIC) circuitry and/or in Digital Signal Processor (DSP) circuitry).

Particularly, the server system 200 and its various components may be enabled using software and/or using transistors, logic gates, and electrical circuits (for example, integrated circuit circuitry such as ASIC circuitry). Various embodiments of the invention may include one or more computer programs stored or otherwise embodied on a computer-readable medium, wherein the computer programs are configured to cause a processor or computer to perform one or more operations. A computer-readable medium storing, embodying, or encoded with a computer program, or similar language, may be embodied as a tangible data storage device storing one or more software programs that are configured to cause a processor or computer to perform one or more operations. Such operations may be, for example, any of the steps or operations described herein. In some embodiments, the computer programs may be stored and provided to a computer using any type of non-transitory computer-readable media. Non-transitory computer-readable media include any type of tangible storage media. Examples of non-transitory computer-readable media include magnetic storage media (such as floppy disks, magnetic tapes, hard disk drives, etc.), optical magnetic storage media (e.g., magneto-optical disks), CD-ROM (compact disc read only memory), CD-R (compact disc recordable), CD-R/W (compact disc rewritable), DVD (Digital Versatile Disc), BD (BLU-RAY® Disc), and semiconductor memories (such as mask ROM, PROM (programmable ROM), EPROM (erasable PROM), flash memory, RAM (random access memory), etc.). Additionally, a tangible data storage device may be embodied as one or more volatile memory devices, one or more non-volatile memory devices, and/or a combination of one or more volatile memory devices and non-volatile memory devices. In some embodiments, the computer programs may be provided to a computer using any type of transitory computer-readable media. Examples of transitory computer-readable media include electric signals, optical signals, and electromagnetic waves. Transitory computer-readable media can provide the program to a computer via a wired communication line (e.g., electric wires, and optical fibres) or a wireless communication line.

Various embodiments of the present disclosure provide multiple advantages and technical effects. The present disclosure mainly provides a digital profile. The digital profile is focused on sharing the online presence of a digital profile entity (a user). This enables the digital profile entity to feature his/her online presence and reputation. Further, the present disclosure allows the digital profile entity to use sharing tools and request review tools associated with the digital profile for ongoing improvement of their online reputation. Additionally, the updates related to the digital profile is communicated to the digital profile entity at regular intervals for improving and/or managing their digital profile.

Various embodiments of the disclosure, as discussed above, may be practiced with steps and/or operations in a different order, and/or with hardware elements in configurations, which are different than those which are disclosed. Therefore, although the disclosure has been described based upon these exemplary embodiments, it is noted that certain modifications, variations, and alternative constructions may be apparent and well within the spirit and scope of the disclosure.

Although various exemplary embodiments of the disclosure are described herein in a language specific to structural features and/or methodological acts, the subject matter defined in the appended claims is not necessarily limited to the specific features or acts described above. Rather, the specific features and acts described above are disclosed as exemplary forms of implementing the claims.

What is claimed is:

1. A computer-implemented method, comprising:
analysing, by the processor, a plurality of profile data points associated with a digital profile of a user, wherein the plurality of profile data points is associated with a corresponding digital platform of a plurality of digital platforms, the plurality of profile data points comprising information related to at least one of the profile information, profile reviews, and profile settings;
computing, by the processor, a grade for each of the plurality of profile data points associated with the plurality of digital platforms based, at least in part, on analysis of the plurality of profile data points, the grade indicating a weightage of each of the plurality of profile data points; and
computing, by the processor, a reputation grade indicative of the online reputation and listings of the digital profile associated with the user based, at least in part, on the grade assigned for the plurality of profile data points.

2. The computer-implemented method as claimed in claim 1, further comprising:
computing, by the processor, a cumulative grade for each of the plurality of digital platforms based at least on the grade assigned to each of the plurality of profile data points associated with the corresponding digital platform of the plurality of digital platforms,
wherein the reputation grade indicative of the online reputation and listings of the digital profile of the user is computed based at least on the cumulative grade of each of the plurality of digital platforms.

3. The computer-implemented method as claimed in claim 1, wherein the plurality of profile data points corresponds to predefined analytical templates for the plurality of digital platforms that are associated with grading the digital profile of the user.

4. The computer-implemented method as claimed in claim 1, further comprising:
monitoring, by the processor, one or more attributes associated with the digital profile of the user at regular intervals, the one or more attributes corresponding to the plurality of profile data points, content, and reviews; and
dynamically computing, by the processor, the reputation grade for the digital profile associated with the user corresponding to determining at least one attribute among the one or more attributes is updated for the digital profile associated with the user.

5. The computer-implemented method as claimed in claim 1, further comprising determining, by the processor, the online reputation and listings of the digital profile of the user based at least on accessing search results from one or more search engines.

6. The computer-implemented method as claimed in claim 1, further comprising generating, by the processor, an analytics report for the user based at least on details in the plurality of profile data points, the grade associated with each of the plurality of profile data points, the cumulative grade associated with each of the plurality of digital platforms, and the reputation grade for the digital profile of the user.

7. The computer-implemented method as claimed in claim 1, further comprising:
determining, by the processor, one or more errors associated with the digital profile being listed in the plurality of digital platforms; and
generating, by the processor, recommendations to the user of the digital profile based at least on the one or more errors associated with the digital profile in the corresponding digital platform.

8. The computer-implemented method as claimed in claim 1, further comprising:
creating, by the processor, a review link for each of the plurality of digital platforms; and
transmitting, by the processor, the review link to at least one client user for seeking reviews on the digital profile associated with the user.

9. The computer-implemented method as claimed in claim 8, further comprising receiving, by the processor, at least one input related to customization of the reviews for the digital profile from the user, the at least one input comprising upload custom reviews to the digital profile, and controlling display of reviews for the digital profile.

10. A server system, comprising:
a communication interface;
a memory storing executable instructions; and
a processor operatively coupled with the communication interface and the memory, the processor configured to execute the executable instructions to cause the application server to at least:
analyse a plurality of profile data points associated with a digital profile of a user, wherein the plurality of profile data points is associated with a corresponding digital platform of a plurality of digital platforms, the plurality of profile data points comprising information related to at least one of the profile information, profile reviews, and profile settings,
compute a grade for each of the plurality of profile data points associated with the plurality of digital platforms based, at least in part, on analysis of the plurality of profile data points, the grade indicating a weightage of each of the plurality of profile data points, and
compute a reputation grade indicative of the online reputation and listings of the digital profile associated with the user based, at least in part, on the grade assigned for the plurality of profile data points.

11. The server system as claimed in claim 10, wherein the server system is caused to at least:
compute a cumulative grade for each of the plurality of digital platforms based at least on the grade assigned to each of the plurality of profile data points associated with the corresponding digital platform of the plurality of digital platforms,
wherein the reputation grade indicative of the online reputation and listings of the digital profile of the user is computed based at least on the cumulative grade of each of the plurality of digital platforms.

12. The server system as claimed in claim 10, wherein the plurality of profile data points corresponds to predefined analytical templates for the plurality of digital platforms that are associated with grading the digital profile of the user.

13. The server system as claimed in claim 10, wherein the server system is caused to at least:
monitor one or more attributes associated with the digital profile of the user at regular intervals, the one or more attributes corresponding to the plurality of profile data points, content, and reviews; and
dynamically compute the reputation grade for the digital profile associated with the user corresponding to determining at least one attribute among the one or more attributes is updated for the digital profile associated with the user.

14. The server system as claimed in claim 10, wherein the server system is caused to at least determine the online reputation and listings of the digital profile of the user based at least on accessing search results from one or more search engines.

15. The server system as claimed in claim 10, wherein the server system is caused to at least generate an analytics report for the user based at least on details in the plurality of profile data points, the grade associated with each of the plurality of profile data points, the cumulative grade associated with each of the plurality of digital platforms, and the reputation grade for the digital profile of the user.

16. The server system as claimed in claim 10, wherein the server system is caused to at least:
determining, by the processor, one or more errors associated with the digital profile being listed in the plurality of digital platforms; and
generating, by the processor, recommendations to the user of the digital profile based at least on the one or more errors associated with the digital profile in the corresponding digital platform.

17. The server system as claimed in claim 10, wherein the server system is caused to at least:
creating, by the processor, a review link for each of the plurality of digital platforms; and
transmitting, by the processor, the review link to at least one client user for seeking reviews on the digital profile associated with the user.

18. The server system as claimed in claim 17, wherein the server system is caused to at least receive at least one input related to customization of the reviews for the digital profile from the user, the at least one input comprising upload custom reviews to the digital profile, and controlling display of reviews for the digital profile.

19. A non-transitory computer-readable storage medium comprising computer-executable instructions that, when executed by at least a processor of a server system, cause the server system to perform a method comprising:
analysing a plurality of profile data points associated with a digital profile of a user, wherein the plurality of profile data points is associated with a corresponding digital platform of a plurality of digital platforms, the plurality of profile data points comprising information related to at least one of the profile information, profile reviews, and profile settings;
computing a grade for each of the plurality of profile data points associated with the plurality of digital platforms based, at least in part, on analysis of the plurality of profile data points, the grade indicating a weightage of each of the plurality of profile data points; and
computing a reputation grade indicative of the online reputation and listings of the digital profile associated with the user based, at least in part, on the grade assigned for the plurality of profile data points.

20. The non-transitory computer-readable storage medium as claimed in claim 19, further comprising:
computing a cumulative grade for each of the plurality of digital platforms based at least on the grade assigned to each of the plurality of profile data points associated with the corresponding digital platform of the plurality of digital platforms,
wherein the reputation grade indicative of the online reputation and listings of the digital profile of the user is computed based at least on the cumulative grade of each of the plurality of digital platforms, and
wherein the plurality of profile data points corresponds to predefined analytical templates for the plurality of digital platforms that are associated with grading the digital profile of the user.
